(19) United States
(12) Patent Application Publication
(10) Pub. No.: US 2005/0021737 A1
(43) Pub. Date: Jan. 27, 2005

(54) Liveness protocol

(76) Inventors: Carl M. Ellison, Portland, OR (US); Maarten Peter Bodlaender, Eindhoven (NL); Jarno Guidi, Eindhoven (NL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/690,096

(22) Filed: Oct. 21, 2003

Related U.S. Application Data
(60) Provisional application No. 60/467,294, filed on May 1, 2003.
(60) Provisional application No. 60/489,860, filed on Jul. 23, 2003.

(51) Int. Cl. G06F 15/173

(52) U.S. Cl. 709/224; 709/227

(57) ABSTRACT

A network includes a connected device and a connected client. The device includes a receiver to receive ping messages, a counter to count the ping messages received, and a transmitter to transmit a reply message that includes a ping load value that is responsive to the count value. The client includes a timer to measure a delay time, a transmitter to transmit a ping message to the device after the delay time has elapsed since transmitting a previous ping message to the device, a receiver to receive the reply message, and a controller to adjust the delay time responsive to the device ping load.

### CROSS REFERENCE TO RELATED APPLICATIONS

This application claims the benefit of U.S. Provisional Applications No. 60/467,294, filed May 1, 2003, and No. 60/489,860, filed Jul. 23, 2003.

### BACKGROUND OF THE INVENTION

Networks may provide connectivity among stand-alone devices and personal computers (PCs) from many different vendors. A network may include a multitude of devices including those in the productivity domain (like desktop PCs, printers, and scanners), the entertainment domain (like televisions and audio sets), home control (like lighting and thermostat control), and the mobile domain (like laptops, universal remote controls, mobile phones, and personal digital assistants). These devices may be removably connected to the network to create a network with a dynamic configuration and transient reachability of devices. One such network is a UPnP™ (a certification mark of the UPnP Implementers Corporation) network.

To reduce or eliminate the requirement for network administrators, devices added to a network may be “plug and play”. There may be seamless roaming of devices between different networks. The number of devices may range from a few to thousands in a single network. All or part of the network may be wireless and may have a low maximum packet size, which places strict upper bounds on the size of multicast User Datagram Protocol (UDP) packets. Wireless networks may have low reliability, low bandwidth, and frequent changes in topology. The devices may have limited processing and memory capabilities.

The network may include two logical entities: clients and devices. Devices act as servers to clients. One physical device, like a PC, can host multiple logical entities. Thus, a physical device can be a client and a device at the same time. A client may discover devices that are on the network and may find out what services they deliver. When needed, the client may make use of these services. In a UPnP™ network, clients may be termed “control points”.

### BRIEF DESCRIPTION OF THE DRAWINGS

FIG. 1 is a block diagram of a network that includes clients and devices.

FIG. 2 is a chart that shows the interaction of ping messages and reply messages between clients and devices.

FIG. 3 is a chart that shows the propagation of proxy-bye messages.

### DETAILED DESCRIPTION OF THE INVENTION

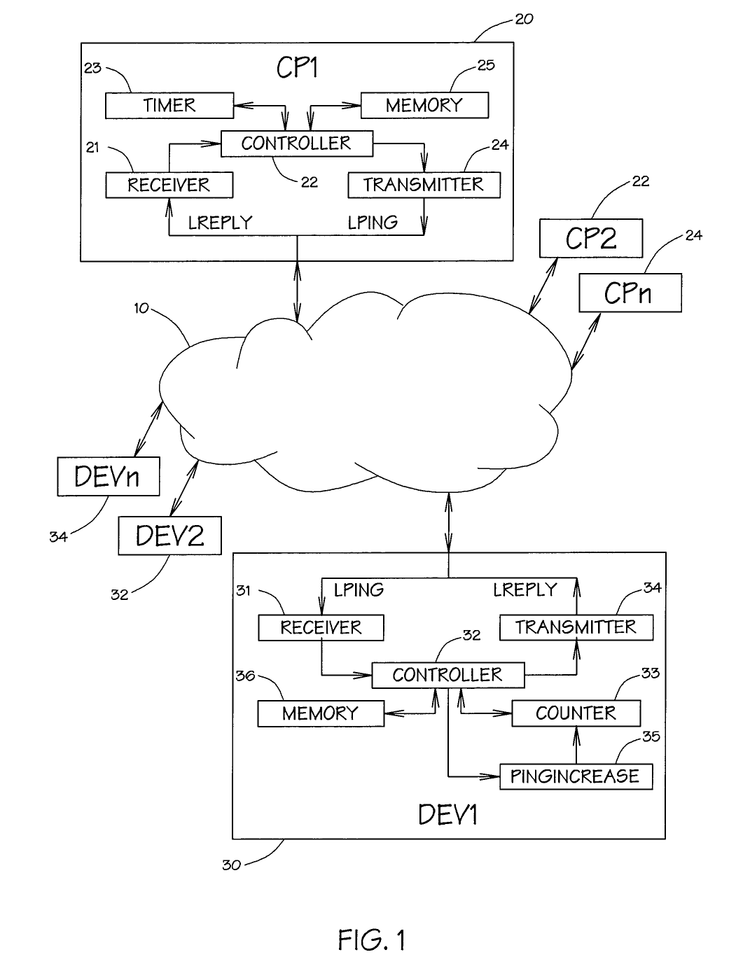

A Liveness Ping Protocol may be defined for a network 10 that includes clients 20 and devices 30 as shown in FIG. 1, such as a UPnP™ (a certification mark of the UPnP Implementers Corporation) network. The Liveness Ping Protocol may allow clients 20 to determine what devices 30 are reachable while controlling the overhead of the protocol on each device. If a client 20 wants to check a particular subset of devices 30, it may start a session of the Liveness Ping Protocol for each device to be checked. Clients 20 may be able to change that subset at will. A client may not be forced to use Liveness Ping Protocol. In an exemplary embodiment, the subset of devices may be allowed to be empty.

A client may check for the presence of a device by sending an LPING message, which may be sent using unicast User Datagram Protocol (UDP). The device may reply with an LREPLY message, which may be in a UDP unicast packet. If the client does not receive a reply before a timeout, it may retransmit the LPING messages a number of times, for example three times. If the device does not reply to the LPING message, or the retransmissions if used, with an LREPLY message within a certain length of time, the client may conclude that the device is unreachable. The use of unicast instead of multicast communication may reduce network and device load in larger networks. UDP may be preferred over TCP, which requires more time and resources to setup and maintain connections, to support high dynamics in resource-constrained devices.

The following are exemplary definitions of the LPING and LREPLY messages in Backus-Naur Form (BNF) notation. Words in double quotes are terminals. Other words are non-terminals.

| | | |
|---|---|---|
| LPING | ::= | “LPING: ” + Port + “\r\n” + Extensions |
| LREPLY | ::= | “LREPLY: ” + PINGLOAD \| PINGCOUNT + “\r\n” + |
| | | CP1: IPaddress +“:”+Port + “\r\n” + |
| | | CP2: IPaddress +“:”+Port + “\r\n” + Extensions |
| PINGCOUNT | ::= | <integer, may wrap-around> |
| IPaddress | ::= | <any legal IPv4/IPv6 address> |
| Port | ::= | <any legal IP port> |
| Extensions | ::= | NAME + “:” + VALUE + “\r\n” \| |
| | | XMLfragment + “\r\n” \| |
| | | Extensions + Extensions |
| NAME | ::= | <string> |
| VALUE | ::= | <string> |
| XMLfragment | ::= | <normal XML, can include or exclude headers> |

The extensions are optional. A sender of a message is never required to include extensions. A receiver of a message may ignore any extensions that are included in a message.

The LPING and LREPLY messages may contain the following information:
LPING:
   client ADDRESS
LREPLY:
   PINGLOAD or PINGCOUNT
      The ping load might become too much for a device if a large number of clients are checking its liveness. To avoid overloading the device, a mechanism for bounding the ping load may be provided by the Liveness Ping Protocol. The LREPLY message may include a ping load value that is indicative of the number of ping messages being handled by the device. In one embodiment the ping load value may be PINGLOAD, which is the number of LPING messages per unit of time, for example messages per second, being received by a device. In another embodiment the ping load value may be PINGCOUNT, which is a value of a counter that is incremented for each LPING message received.

When a device receives an LPING message from a client, the device may increase an internal counter, for example PINGCOUNT, by an amount, which may be a constant amount such as PINGINCREASE, to provide a ping control mechanism. The PINGLOAD of a device may be computed as the difference between two successive ping counts, for example PINGCOUNT and LASTPINGCOUNT, divided by the length of time between the two counts, for example PERIOD, which may be expressed in seconds:

$$PINGLOAD = \frac{PINGCOUNT - LASTPINGCOUNT}{PERIOD}$$

It will be appreciated that the internal counter may be of a limited size and may wrap-around when the ping count goes beyond the maximum count that can be represented by the internal counter. The difference between two successive ping counts may be computed in a manner that recognizes that the counter has wrapped-around and produces a difference value as though the counter were large enough not to wrap-around. Other methods of computing PINGLOAD may be used such as using a period that encompasses several received LPING messages, computing a running average for PINGLOAD, or computing PINGLOAD at fixed intervals.

In one embodiment, the device may compute a device ping load, such as PINGLOAD, and return the value of the device ping load to the client that sent the LPING message in the LREPLY response message. In another embodiment, the device may return the current value of PINGCOUNT to the client that sent the LPING message in the LREPLY response message. An exemplary behavior of the device in this embodiment may be described by the following pseudo-code:
1 FOR each incoming LPING message from client CP containing the ADDRESS of client CP DO
2 PINGCOUNT=PINGCOUNT+PINGINCREASE
3 Send LREPLY message containing PINGCOUNT
Clients may maintain the last PINGCOUNT value they received from the device as, for example LASTPINGCOUNT, and compute the device ping load using a difference between a ping load value, PINGCOUNT, and the previously received ping load value, LASTPINGCOUNT. Furthermore, clients may time the interval between consecutive LPINGs sent to a device as PERIOD. Using these values, a client may calculate the device ping load, PINGLOAD, when the client receives an LREPLY message:

$$PINGLOAD = \frac{PINGCOUNT - LASTPINGCOUNT}{PERIOD}$$

To limit the PINGLOAD of a device, clients may be required to have at least a certain DELAY, which may further include a small randomization value, between two consecutive LPING messages. The value of this DELAY may be specified by a set of rules. Clients may be allowed to wait longer than the DELAY to send an LPING message. Thus DELAY may be a lower bound for PERIOD. When a client detects that the PINGLOAD on a device is higher than a certain threshold, for example HIGHTHRESHOLD, it may increase this DELAY to lower the effective PINGLOAD. When a client detects that the PINGLOAD falls below a certain threshold, for example LOWTHRESHOLD, it may decrease this DELAY to raise the effective PINGLOAD. This may be captured by the following exemplary adaptation rules:
(R1) If PINGLOAD>HIGHTHRESHOLD then DELAY=2× DELAY
(R2) If PINGLOAD<LOWTHRESHOLD then DELAY=⅔× DELAY

The parameters HIGHTHRESHOLD and LOWTHRESHOLD may be fixed constants expressed in pings per unit time, for example pings per second. The constants may be defined such that they lead to an acceptable load on the device. The difference between HIGHTHRESHOLD and LOWTHRESHOLD may be made large enough that the DELAY stabilizes between HIGHTHRESHOLD and LOWTHRESHOLD quickly. In an exemplary embodiment, an increase of DELAY with a constant of 2 in rule R1 and the decrease of DELAY with a constant of ⅔ in rule R2 were used. The ratio LOWTHRESHOLD/HIGHTHRESHOLD in this exemplary embodiment was smaller than ⅔, so that the DELAY quickly attained a value between HIGHTHRESHOLD and LOWTHRESHOLD. The choice for these values may be based on simulation results.

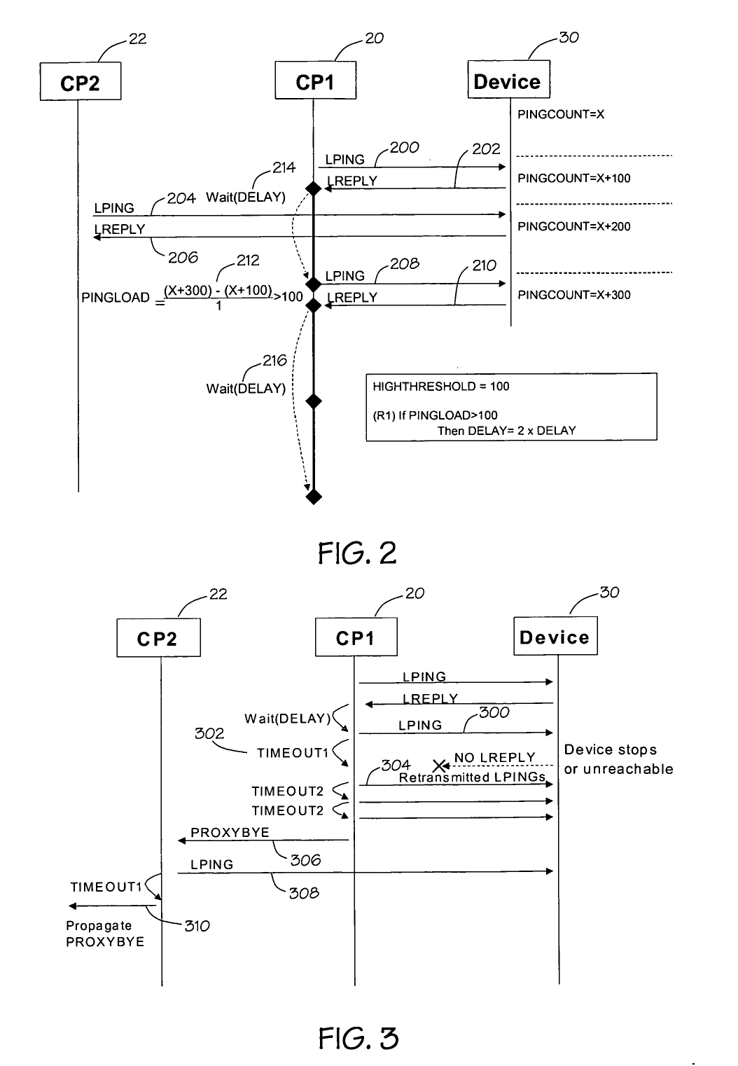

FIG. 2 shows an exemplary embodiment with instantiated values for the different thresholds. The device 30 has a PINGINCREASE value of 100. Client CP1 20 is pinging the device 30 once every second. The current PINGLOAD is equal to the high threshold value of 100. Client CP1 20 sends an LPING 200. The device 30 sends an LREPLY 202 that includes a PINGCOUNT value of X+100, which is one PINGINCREASE more than the previous LREPLY sent to client CP1 because no other client is pinging the device 30. After CP2 22 starts pinging the same device, the device 30 increases PINGCOUNT after receiving the LPING 204 from CP2 and sends an LREPLY 206 to CP2 with a PINGCOUNT value of X+200. Client CP1 20 sends its next LPING 208 a DELAY time 214 of about one second after the preceding LREPLY 202. The device 30 increases PINGCOUNT after receiving the LPING 208 from CP1 and sends an LREPLY 210 to CP1 with a PINGCOUNT value of X+300. CP1 detects that the high threshold has been exceeded because the intervening ping by CP2 causes the following PINGCOUNT seen by CP1 to increase by 200 rather than 100 as it did before CP2 started pinging. CP1 computes the PINGLOAD to 200 as shown by equation 212. Consequently CP1 doubles its DELAY 216 between successive pings of the device to about two seconds.

In a similar way, if client CP2 stops pinging the device, the PINGLOAD decreases. CP1 will see the following PINGCOUNT increase by 100 rather than 200 as it did while CP2 was pinging. When the PINGLOAD is smaller than the low threshold, rule R2 may be applied and CP1 may decrease its DELAY.

In dynamic environments, the set of clients that is interested in a single device may change rapidly. While rules R1 and R2 may automatically adapt DELAYs to changed conditions, a sudden reduction in the number of clients can lead to a too low PINGLOAD to ensure timely detection of device unavailability. It can take a long time until the remaining clients ping again and notice that they can increase their ping frequency. To limit this effect, the maximum DELAY may be bounded by a factor that may be termed MAXDELAY. Adaptation rule R1 may become:
(R1) If PINGLOAD>HIGHTHRESHOLD then DELAY=min(MAXDELAY, 2× DELAY)

Similarly, a sudden influx of new clients can temporarily lead to a PINGLOAD above the high threshold. To limit this effect, a minimum DELAY, MINDELAY, may be introduced. Adaptation rule R2 may become:
(R2) If PINGLOAD<LOWTHRESHOLD then DELAY=max(MINDELAY, ⅔ DELAY)
   Both MAXDELAY and MINDELAY may be constants and may be expressed in seconds.

Devices may tune their PINGLOAD by choosing, either statically or dynamically, the value of the variable PINGINCREASE that increments PINGCOUNT for each ping received by the device. When the protocol stabilizes, the maximum number of LPING messages per second that the device serves is:

$$MAX PINGPER SEC = \frac{HIGHTHRESHOLD}{PINGINCREASE}$$

In the exemplary embodiment shown in FIG. 2, a PINGINCREASE of 100 resulted in receiving no more than 1 LPING per second since the HIGHTHRESHOLD equaled 100. More powerful devices can choose lower PINGINCREASE values. For example, with a PINGINCREASE of 1, up to 100 liveness pings might be received per second in the stable situation. Modifying the PINGINCREASE may limit the load on the network and on the device without requiring negotiations or further operations.

The Liveness Ping Protocol may ensure that the PINGLOAD of one device does not go above MAXPINGPERSEC. Devices may not have to send and receive more than 2× MAXPINGPERSEC packets/second. As an exception to this rule, to ensure self-healing in a dynamic environment, clients may be allowed to ping once every MAXDELAY seconds, even if the number of clients grows beyond MAXDELAY×MAXPINGPERSEC. If there are #C clients and #D devices, then the number of messages involved in the Liveness Ping Protocol may be as follows:

$$\# Messages = 2 \times \# D \times max ( \frac{\# C}{MAX DELAY} , min ( \frac{\# C}{MIN DELAY} , MAX PINGPER SEC ) )$$

The Liveness Ping Protocol may limit the overhead of PING messages on devices by increasing the time between successive pings from a client. This may increase the length of time it takes a client to detect the disappearance of a device from the network. A Proxy-Bye Protocol may be used to notify clients more quickly of the disappearance of a device from the network. The Proxy-Bye Protocol takes place only among clients. If a large number of clients are checking liveness of the same device, the clients will have long DELAYs between consecutive LPING messages (due to PINGLOAD control). To ensure that clients discover as soon as possible that the device becomes unreachable, the first client that detects that the device is gone notifies the others through the Proxy-Bye Protocol.

A client CP may check for the presence of the device by sending an LPING message. The device may respond to the client CP with an LREPLY message. If the client does not receive a reply before a timeout, it may retransmit the LPING messages a number of times. If the device does not reply to the LPING message, or the retransmissions if used, within a certain length of time, the client may conclude that the device is unreachable and the Proxy-Bye Protocol may be invoked.

Whenever a client decides that the device has become unreachable, it notifies other clients by sending proxy-bye messages. A proxy-bye message contains the address of the device and the LASTPINGCOUNT received by the client that generates the proxy-bye message. The LASTPINGCOUNT information enables other clients to discard duplicate proxy-bye messages.

Address information may be exchanged between clients piggybacked on the LREPLY messages to provide a zero-message overhead dynamic membership mechanism. The address may consist of an IP address and UDP port. To facilitate this exchange of information, each device may maintain the address information for the last several clients that sent an LPING, and may return this address information in the LREPLY. In one embodiment, each device may maintain address information for the last two clients that sent an LPING. The LREPLY message may contain the following information:
LREPLY:
   PINGCOUNT,
   client1 ADDRESS
   client2 ADDRESS
      An exemplary behavior of the device in the embodiment that includes the last two clients in an LREPLY may be described by the following pseudo-code:
1 FOR each incoming LPING message from client CP containing the ADDRESS of client CP DO
2 PINGCOUNT=PINGCOUNT+PINGINCREASE
3 Send LREPLY message containing PINGCOUNT and ADDRESS of the last two clients
4 IF CP is not one of the last two clients THEN
5 Remove information about the oldest client
6 Store information about client CP

Clients may use this information to dynamically determine which other clients are checking the same device in the Proxy-Bye Protocol. This may occur without any direct communication among the group members and without any additional messages.

A client may send the proxy-bye message to all other known clients that are checking the same device by using a combination of multicast and unicast messages. If there is at least one client on the local link, the proxy-bye message is multicast on the local link. All off-link clients are reached by means of unicast messages.

Upon receiving a proxy-bye message, a client may check whether the proxy-bye message is a duplicate (i.e. a similar message was already received) or the device is still reachable, before deciding that the device is unreachable. If the proxy-bye message is not a duplicate and the device is not reachable, the device may forward the proxy-bye message. This may protect dynamic, routed networks where messages can appear out of order from propagating duplicate or outdated messages, and spoof attacks in case of malicious proxy-bye messages.
1 IF device already considered unreachable THEN ignore message
2 IF LASTPINGCOUNT is old THEN ignore message
3 Send a LPING to the device
4 IF an LREPLY is received THEN ignore message
5 On timeout, consider the device unreachable
6 IF the proxy-bye was received through unicast THEN
7 IF other clients on the same link are known
8 Multicast proxy-bye local link
9 Unicast proxy-bye to off-link clients

FIG. 3 shows the flow of messages when a device 30 becomes unreachable for an exemplary embodiment. Client CP1 20 sends an LPING message 300. CP1 does not receive an LREPLY within a predetermined time 302. CP1 may retransmit the LPING 304 one or more times. If CP1 does not receive an LREPLY, it transmits a PROXYBYE message 306 to client CP2 22. Client CP2 may then send an LPING message 308 to the device 30. If CP2 does not receive an LREPLY, it propagates the proxy-bye by transmitting a PROXYBYE message 310 to another client.

Each time a client CP1 receives an LREPLY message, it may receive the addresses of a number, such as two, preceding clients CP2, CP3. After a sequence of LPINGS by client CP1, differences in ping frequencies make it likely that it has received the addresses of a larger set of clients {CP2, . . . , CPn}. This effect may improve reliability of the Proxy-Bye Protocol, but may increase bandwidth and processing requirements of the protocol. To limit the size of this set {CP2, . . . , CPn}, CP1 may be allowed to forget about old clients. When CP1 receives information about CPi at time T, it may have to keep the information about CPi at least until T+MAXDELAY. Afterwards information about CPi is old and may be removed. This may assure that a client is known by at least two other clients at all times, unless these clients left the network. Moreover, since the proxy-bye message may be multicast on the local link, in small, bridged networks all clients may be notified at the same time. The propagation pattern of proxy-bye messages may be called the spreading effect. With high probability the forwarding graph may have a depth of log(#clients), which may allow fast propagation, even across the Internet. After each liveness ping, the forwarding connections between clients may be automatically updated to reflect the latest set of interested clients. Therefore it is likely that the proxy-bye messages will reach all clients.

It will be appreciated that the Liveness Ping Protocol may be used with or without the Proxy-Bye Protocol. Also, that the Proxy-Bye Protocol without the Liveness Ping Protocol. Both may be used advantageously together by placing a PINGLOAD or PINGCOUNT value and client addresses in the same LREPLY message. In other embodiments, PINGLOAD or PINGCOUNT values and client addresses may be sent in different messages. While the Liveness Ping Protocol and the Proxy-Bye Protocol have been described in the context of UPnP™ networks, these protocols may be used with other types of networks.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A device to be connected to a network, the device comprising:
a receiver to receive ping messages from a plurality of clients connected to the network;
a counter coupled to the receiver, the counter to increment a count value for each of the ping messages the receiver receives from the plurality of clients; and,
a transmitter coupled to the receiver and the counter, the transmitter to transmit a reply message that includes a ping load value that is responsive to the count value.

2. The device of claim 1 wherein the reply message is a unicast User Datagram Protocol (UDP) message.

3. The device of claim 1 wherein the counter increments the count value by an increment that is inversely proportional to a desired device ping load.

4. The device of claim 1 wherein the counter increments the count value by an increment that can be changed by the device.

5. The device of claim 1 wherein the ping load value is the count value.

6. The device of claim 1 further comprising a memory to store an address of one of the plurality of clients from which a ping message was most recently received, wherein the reply message further includes the address.

7. A client connected to a network, the client comprising:
a timer to measure a delay time;
a transmitter coupled to the timer, the transmitter to transmit a ping message to a device connected to the network after the timer signals that the delay time has elapsed since the transmitter transmitted a previous ping message to the device;
a receiver, the receiver to receive a reply message from the device that includes a ping load value that is responsive to a device ping load; and
a controller coupled to the receiver and the timer, the controller to adjust the delay time responsive to the device ping load.

8. The client of claim 7 further comprising a memory to store a previously received ping load value, wherein the ping load value is a count value that the device increments for each ping message the device receives, and the controller adjusts the delay time responsive to a difference between the ping load value and the previously received ping load value.

9. The client of claim 8 wherein the controller adjusts the delay time further responsive to a time interval between ping messages that correspond to reply messages that include the ping load value and the previously received ping load value.

10. The client of claim 8 wherein the transmitter is further to transmit a proxy-bye message to a second client connected to the network if the receiver does not receive the reply message from the device within a predetermined time, the proxy-bye message including an address of the device and the previously received ping load value.

11. The client of claim 7 wherein the controller adjusts the delay time to be not less than a predetermined minimum delay time.

12. The client of claim 7 wherein the controller adjusts the delay time to be not more than a predetermined maximum delay time.

13. The client of claim 12 wherein the controller adjusts the delay time to be not less than a predetermined minimum delay time.

14. The client of claim 7 wherein the controller adjusts the delay time by multiplying the delay time by a first predetermined value if the device ping load is below a low threshold, and by multiplying the delay time by a second predetermined value if the device ping load is above a second threshold.

15. A method for controlling a device ping load, the method comprising:
receiving ping messages from a plurality of clients connected to the network;
incrementing a count value for each of the ping messages received from the plurality of clients; and,
transmitting a reply message that includes a ping load value that is responsive to the count value.

16. The method of claim 15 wherein the reply message is a unicast User Datagram Protocol (UDP) message.

17. The method of claim 15 wherein the count value is incremented by an increment that is inversely proportional to a desired device ping load.

18. The method of claim 15 wherein the ping load value is the count value.

19. The method of claim 15 further comprising storing an address of one of the plurality of clients from which a ping message was most recently received, wherein the reply message further includes the address.

20. A method for controlling a device ping load, the method comprising:
transmitting a ping message to a device connected to a network after a delay time has elapsed since transmitting a previous ping message to the device;
receiving a reply message from the device that includes a ping load value that is responsive to a device ping load; and
adjusting the delay time responsive to the device ping load.

21. The method of claim 20 further comprising storing a previously received ping load value, wherein the ping load value is a count value that the device increments for each ping message the device receives, wherein adjusting the delay time is further responsive to a difference between the ping load value and the previously received ping load value.

22. The method of claim 21 wherein adjusting the delay time is further responsive to a time interval between ping messages that correspond to reply messages that include the ping load value and the previously received ping load value.

23. The method of claim 21 further comprising transmitting a proxy-bye message to a second client connected to the network if the receiver does not receive the reply message from the device within a predetermined time, the proxy-bye message including an address of the device and the previously received ping load value.

24. The method of claim 20 further comprising adjusting the delay time to be not less than a predetermined minimum delay time.

25. The method of claim 20 further comprising adjusting the delay time to be not more than a predetermined maximum delay time.

26. The method of claim 25 further comprising adjusting the delay time to be not less than a predetermined minimum delay time.

27. The method of claim 20 wherein adjusting the delay time includes multiplying the delay time by a first predetermined value if the device ping load is below a low threshold, and by multiplying the delay time by a second predetermined value if the device ping load is above a second threshold.

28. A machine-readable medium comprising instructions which, when executed by a device, cause the device to perform operations including:
transmitting a ping message to a device connected to a network after a delay time has elapsed since transmitting a previous ping message to the device;
receiving a reply message from the device that includes a ping load value that is responsive to a device ping load; and
adjusting the delay time responsive to the device ping load.

29. The machine-readable medium of claim 28 wherein the operations further include storing a previously received ping load value, wherein the ping load value is a count value that the device increments for each ping message the device receives, wherein adjusting the delay time is further responsive to a difference between the ping load value and the previously received ping load value.

30. The machine-readable medium of claim 29 wherein adjusting the delay time is further responsive to a time interval between ping messages that correspond to reply messages that include the ping load value and the previously received ping load value.

31. The machine-readable medium of claim 28 wherein the operations further include transmitting a proxy-bye message to a second client connected to the network if the receiver does not receive the reply message from the device within a predetermined time, the proxy-bye message including an address of the device and the previously received ping load value.

32. The machine-readable medium of claim 28 wherein the operations further include adjusting the delay time to be not less than a predetermined minimum delay time.

33. The machine-readable medium of claim 28 wherein the operations further include adjusting the delay time to be not more than a predetermined maximum delay time.

34. The machine-readable medium of claim 33 wherein the operations further include adjusting the delay time to be not less than a predetermined minimum delay time.

35. The machine-readable medium of claim 28 wherein adjusting the delay time includes multiplying the delay time by a first predetermined value if the device ping load is below a low threshold, and by multiplying the delay time by a second predetermined value if the device ping load is above a second threshold.

36. A network comprising a device connected to the network and a plurality of clients connected to the network, wherein
the device further comprises
a receiver to receive ping messages from the plurality of clients,
a counter coupled to the receiver, the counter to increment a count value for each of the ping messages the receiver receives from the plurality of clients, and,
a transmitter coupled to the receiver and the counter, the transmitter to transmit a reply message that includes a ping load value that is responsive to the count value; and,
each of the plurality of clients further comprises
a timer to measure a delay time,
a transmitter coupled to the timer, the transmitter to transmit a ping message to the device after the timer signals that the delay time has elapsed since the transmitter transmitted a previous ping message to the device,
a receiver, the receiver to receive a reply message from the device that includes a ping load value that is responsive to a device ping load, and
a controller coupled to the receiver and the timer, the controller to adjust the delay time responsive to the device ping load.

37. The network of claim 36 wherein each of the plurality of clients further comprises a memory to store a previously received ping load value, the ping load value being the count value that the device increments for each ping message the device receives, and the controller adjusts the delay time responsive to a difference between the ping load value and the previously received ping load value.

38. The network of claim 37 wherein the transmitter is further to transmit a proxy-bye message to another of the plurality of clients connected to the network if the receiver does not receive the reply message from the device within a predetermined time, the proxy-bye message including an address of the device and the previously received ping load value.
